(19) United States
(12) Patent Application Publication
(10) Pub. No.: US 2006/0017183 A1
(43) Pub. Date: Jan. 26, 2006

(54) Method for manufacturing optical fiber light guide badges

(76) Inventors: Yung Hua Chen, Yung Ho-City (TW); Pi Yin Yang, Yung Ho-City (TW)

Correspondence Address: BIRCH STEWART KOLASCH & BIRCH, PO BOX 747, FALLS CHURCH, VA, 22040-0747, US

(21) Appl. No.: 10/893,978

(22) Filed: Jul. 20, 2004

(51) Int. Cl. B29D 11/00

(52) U.S. Cl. 264/1.24; 264/2.5

(57) ABSTRACT

This invention relates to a method for manufacturing optical fiber light guide badges, which comprises four steps: making a mold, making a badge, connecting optical fibers with the badge, and producing a convex mirror effect on an optical fiber light spot. The foregoing structure can achieve the effects of providing an artistic look to the badge and saving costs.

### FIELD OF THE INVENTION

The present invention relates to a method for manufacturing an optical fiber light guide badge, more particularly to a method for manufacturing an optical fiber light guide badge having an artistic look and a cost-saving effect.

### BACKGROUND OF THE INVENTION

Optical fiber light guide badges are high-tech products having various customer's favorable pictures and signs sewed onto a cap or a backpack together with various light and handy multifunctional electronic drivers can produce diversified dynamic blinker light effects and make such fiber light guide badge become the most fashionable product in the world's clothing industry.

The conventional optical fiber light guide badge includes a badge and an optical fiber and its manufacturing method comprises the steps of making different shaped polyvinyl chloride (PVC), plastic or rubber flat badges by a mold injection or a press shaping method; passing an optical fiber through an eye at the end of a sewing needle; piecing the sewing needle into the backside of the badge and out from the front side of the badge by a knitting method, such that the optical fiber also passes through the badge; repeating the foregoing method to pass each optical fiber through the badge; trimming the portion of the optical fiber protruded from the front side of the badge by a pair of scissors; and finally connecting a plurality of optical fibers with a light emitting diode of an electronic driver, and thus completing the manufacturing process for an optical fiber light guide badge. The light emitted from the light emitting diode is propagated to the end of the optical fiber at the front side of the badge and then spread outward to an end of the optical fiber, such that the optical fiber light guide badge shines.

However, the prior-art manufacturing method for the optical fiber light guide badge still has many shortcomings, wherein the sewing needle pierces through the concave points may damage the optical fibers easily because the material of the optical fiber is unlike the fiber of the general threads of clothing and has a lower flexibility and elasticity. When the optical fiber is bent into a large angle, the optical fiber may break at the bending position easily. If the force pulled by a sewing needle out from the concave points is too large, the optical fiber may be pulled apart. The broken optical fiber may cause the light spots in certain parts of the optical fiber unable to light up and thus making the product look not as good.

Further, the prior-art manufacturing method for the optical fiber light guide badge needs to sew the optical fiber onto the badge by passing the optical fiber into a plurality of concave points on the badge stitch by stitch, and thus consumes lots of time and labor and cannot produce the product in mass quantity. Such method may loose the competitiveness in the market because its cost is too high.

### SUMMARY OF INVENTION

In view of the aforementioned shortcomings of the prior art, the inventor of the present invention based on years of experience in the related industry to conduct researches and experiments, and finally invented a “Method for manufacturing optical fiber light guide badges”.

The primary objective of the present invention is to provide a method for manufacturing an optical fiber light guide badge having an artistic look and saving costs.

To achieve the foregoing objective, the method for manufacturing optical fiber light guide badges in accordance with the present invention comprises four steps of making a mold, making a badge, connecting optical fibers with the badge, and producing a convex mirror effect on an optical fiber light spot. The optical fibers are connected to the badge by piercing a hollow needle into the concave point on the front side of the badge, and an optical fiber passes through the backside of the badge along the hollow duct of the hollow needle. When the hollow needle is pulled away from the badge, the contraction of the badge will place the optical fiber in between the badge. After the badge is processed by sewing the optical fiber and then glued by a polyurethane (PU) material, the convex effect at the light spots of the optical fiber will be produced by heating and solidifying the badge. The foregoing structure can achieve the effects of providing an artistic look to the badge and saving costs.

According to the foregoing structure, the “Method for manufacturing optical fiber light guide badges” in accordance with the present invention directly pierces the optical fiber into the concave point by the hollow duct of the hollow needle, and thus the present invention avoids the optical fiber from being broken due to the bending or pulling of the optical fiber and achieves the artistic look and saves costs.

### BRIEF DESCRIPTION OF THE DRAWINGS

FIG. 1 is a perspective view of the mold and bottom chassis according to the present invention.

FIG. 2 is an illustrative view of pouring the PVC powder and DINP material into the mold and bottom chassis according to the present invention.

FIG. 3 is an illustrative view of removing the badge from the mold and bottom chassis according to the present invention.

FIG. 4 is a cross-sectional view of the badge according to the present invention.

FIGS. 5, 6 and 7 are illustrative views of piercing the hollow needle with the optical fiber through the badge according to the present invention.

FIGS. 8 and 9 are illustrative views of the optical fiber being clipped by the contraction of the badge according to the present invention.

FIG. 10 is an illustrative view of gluing the optical fiber with the badge by a PU material according to the present invention.

### DETAILED DESCRIPTION OF THE PREFERRED EMBODIMENT

The detailed description and technical characteristics of the present invention are described together with the drawings as follows.

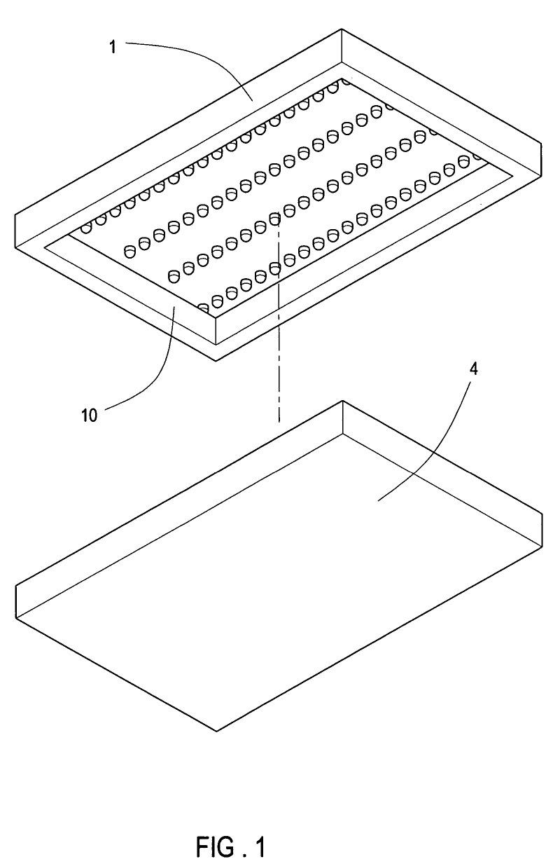

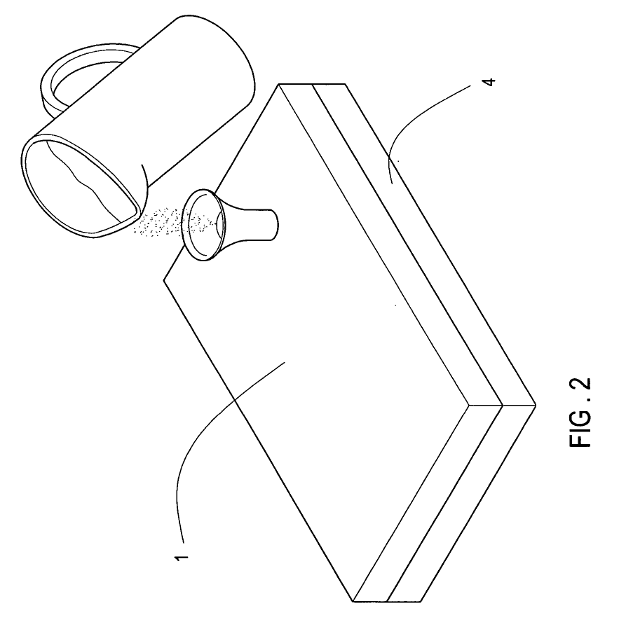

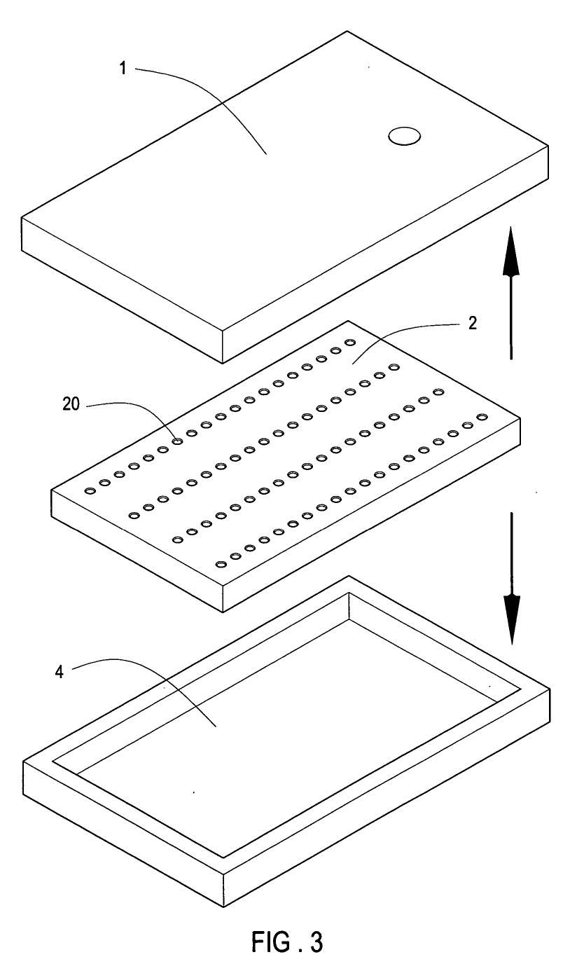

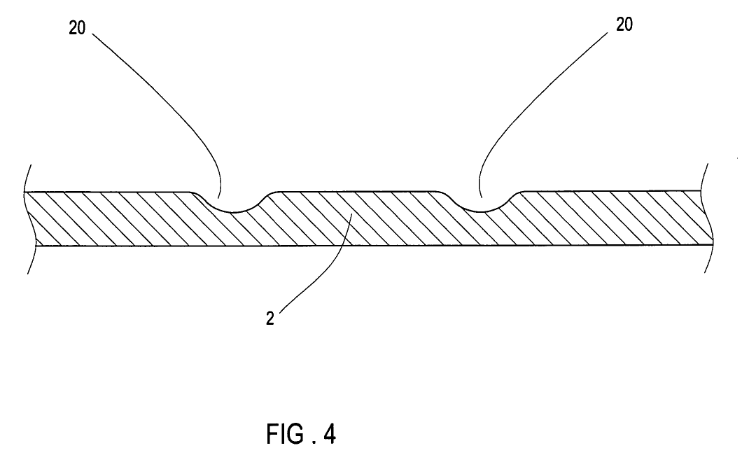

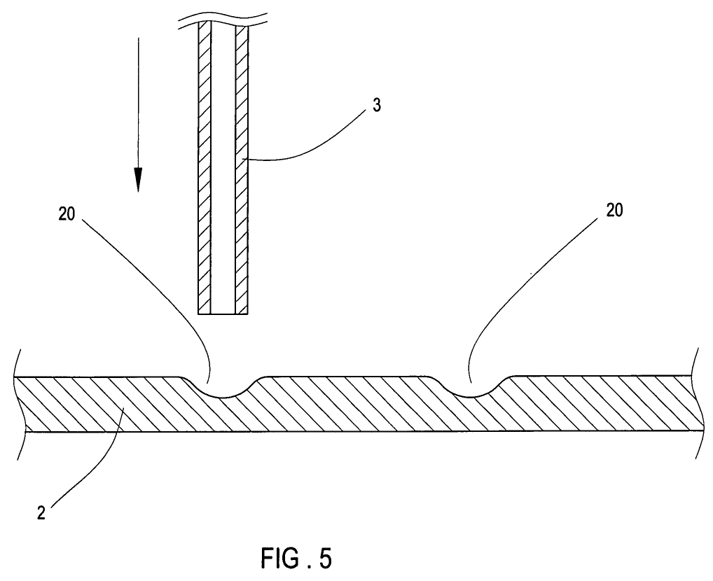

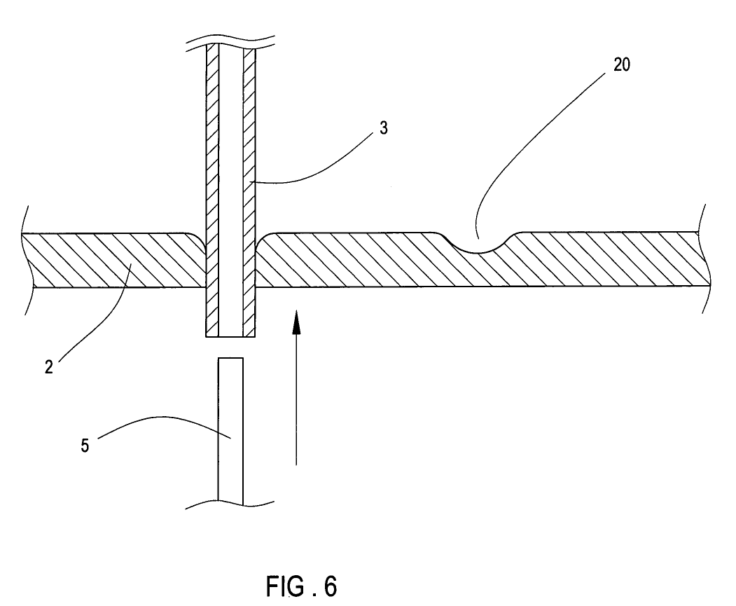

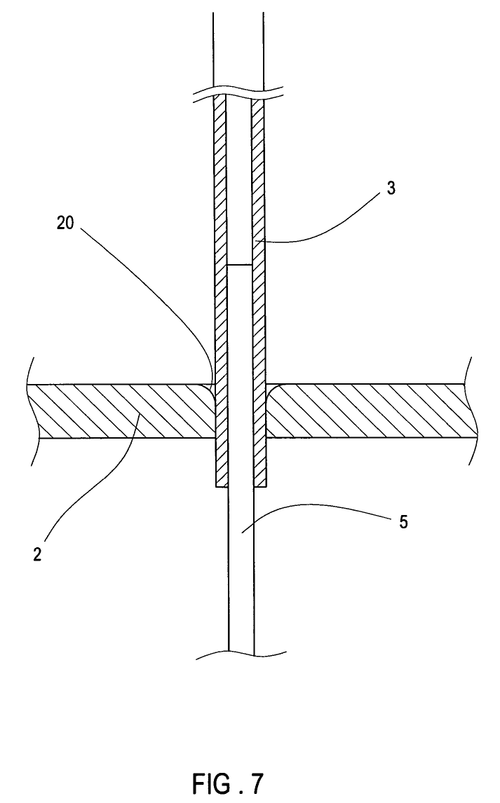

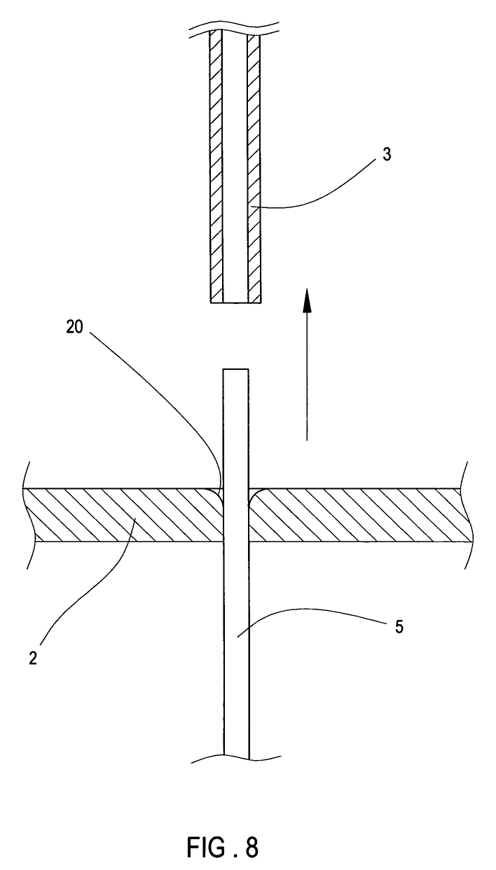

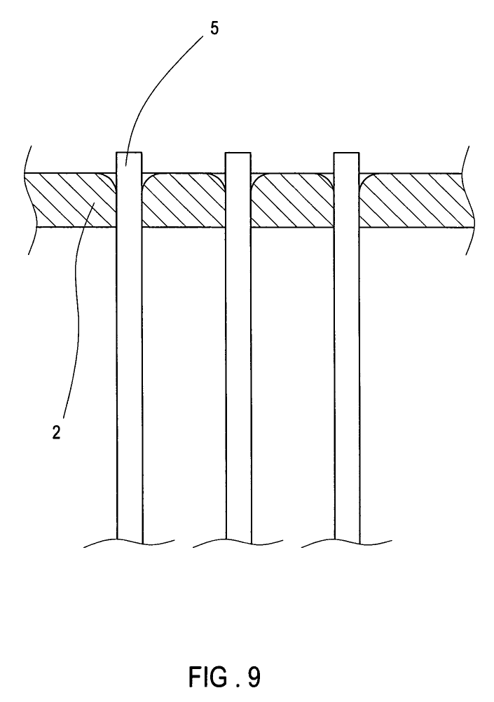

Please refer to FIG. 1 for the method for manufacturing optical fiber light guide badges according to the present invention. Such method includes a mold 1 and a bottom chassis 4 and comprises the steps of:
(a) Making a badge mold 1, and said badge mold 1 having a plurality of convex points 10 preferably having a diameter of 2 mm and a height of 0.5 mm and being disposed on the inner side of said mold according to the position of a figure required for showing an optical fiber light spot and pouring a dye made by mixing a polyvinyl chloride (PVC) powder with a Diisononyl Phthalate (DINP) into said mold 1 as shown in FIG. 2, and forming a PVC badge 2 with said required figure after being heated to produce a plurality of concave points 20 corresponding to said plurality of convex points 10 on said PVC badge 2;
(b) Using a hollow needle 3 to pierce into the front side of said badge 2 as shown in FIG. 5 and passing a hollow duct of said hollow needle 3 with an optical fiber 5 into the backside of said badge 2 as shown in FIGS. 6 and 7;
(c) Removing said hollow needle 3 such that the contraction of said badge 2 clips said optical fiber 5 as shown in FIG. 8; and
(d) Trimming said optical fibers 5 to a same length as shown in FIG. 9 after said optical fibers pass through each concave point 20 of said badge 2 by using said method to complete the manufacture of said optical fiber light guide badge.

Further, the hollow needles 3 as described in Step (b) complete threading the needles 3 by using a tool to align a plurality of hollow needles 3 for the threading.

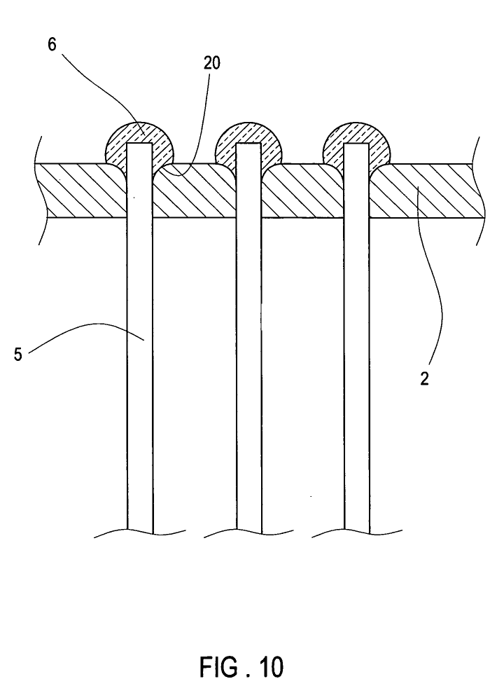

Please refer to FIG. 10 for the foregoing optical fiber light guide badge 2 being glued by a PU material 6 at the position of a concave point 20 on the front side of badge 2, such that the PU material 6 solidifies after being processed by heating to fix the optical fibers 5 onto the badge 2.

In the aforementioned structure, the method for manufacturing optical fiber light guide badges in accordance with the present invention directly inserts the optical fibers by a hollow duct of the hollow needle into the concave points. Therefore the optical fiber will not be bent or pulled to avoid its being broken. The present invention further facilitates the process of inserting the optical fibers in every concave point quickly and thus increasing the production quantity and greatly reducing the manufacturing cost.

After the transparent PU material is heated and solidified, an arc transparent convex point is formed at the position through where the optical fiber passes. The transparent convex point has the effect of a convex mirror to form a spotlight effect, so that the beams emitted from the end of the optical fiber are centralized to give brighter beams of light and a more artistic look.

In summation of the description above, the “Method for manufacturing optical fiber light guide badges” in accordance with the present invention definitely achieves the artistic look and cost-saving effects, and thus the present invention overcomes the shortcomings of the prior-art and enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A method for manufacturing optical fiber light guide badges, including a mold and a bottom chassis and comprising the steps of:
(a) Making a badge mold, and said badge mold having a plurality of convex points disposed on the inner side of said mold according to the position of a figure required for showing an optical fiber light spot and pouring a dye made by mixing a PVC powder with a DINP into said mold, and forming a PVC badge with said required figure after being heated to produce a plurality of concave points corresponding to said plurality of convex points on said PVC badge;
(b) Using a hollow needle to pierce into the front side of said badge and passing a hollow duct of said hollow needle with an optical fiber into the backside of said badge;
(c) Removing said hollow needle such that the contraction of said badge clips said optical fiber; and
(d) Trimming said optical fibers to a same length after said optical fibers pass through each concave point of said badge by using said method to complete the manufacture of said optical fiber light guide badge.

2. The method for manufacturing optical fiber light guide badges of claim 1 wherein said mold at its inner surface comprises a plurality of convex points preferably with a diameter of 2 mm and a height of 0.5 mm.

3. The method for manufacturing optical fiber light guide badges of claim 1, wherein said hollow needles as described in step (b) complete threading said needles by using a tool to align a plurality of hollow needles for the threading.

4. The method for manufacturing optical fiber light guide badges of claim 1, wherein said optical fiber light guide badge is glued with a transparent PU material at the positions on the front side where said optical fibers pass, such that said PU material solidifies after being processed by heating to fix said optical fiber onto said badge.
